(19) United States
(12) Patent Application Publication
(10) Pub. No.: US 2013/0337309 A1
(43) Pub. Date: Dec. 19, 2013

(54) POROUS METAL SUPPORTED THIN FILM SODIUM ION CONDUCTING SOLID STATE ELECTROLYTE

(71) Applicant: Materials and Systems Research, Inc., Salt Lake City, UT (US)

(72) Inventors: Anil V. VIRKAR, Salt Lake City, UT (US); Joon-Ho Koh, Salt Lake City, UT (US); Gege Tao, Salt Lake City, UT (US); Neill Weber, Salt Lake City, UT (US)

(73) Assignee: Materials and Systems Research, Inc., Salt Lake City, UT (US)

(21) Appl. No.: 13/898,441

(22) Filed: May 20, 2013

Related U.S. Application Data
(60) Provisional application No. 61/650,978, filed on May 23, 2012.
(60) Provisional application No. 61/771,507, filed on Mar. 1, 2013.

(51) Int. Cl. H01M 10/39

(52) U.S. Cl. CPC H01M 10/3927
USPC 429/104

(57) ABSTRACT

An electrolyte structure that is useful in battery cells having liquid electrodes and solid electrolyte and in alkali-metal thermoelectric converters is made by applying a dense film of a solid alkali-metal ion conductor on a thick porous metal support.

### CROSS REFERENCE TO RELATED APPLICATIONS

Priority is claimed from U.S. Provisional Patent Applications 61/650978, filed 23 May 2012, and 61/771507, filed 1 Mar. 2013, which are hereby incorporated by reference.

### FEDERAL SUPPORT

This invention was made with government support under Contract No. DE-AR0000263 awarded by United States Department of energy. The government has certain rights in the invention.

### BACKGROUND

Sodium ion conducting solid-state electrolytes have been widely used in applications such as sodium-batteries and thermoelectric converters. For example, in a sodium/sulfur battery cell, a solid-state electrolyte, such as beta″-alumina solid electrolyte (BASE) or sodium super ion conductor (NASICON), is disposed between a molten sodium anode and a molten cathode, such as sulfur or metal halide (nickel/NaCl). During discharge, sodium atoms in the anode donate electrons and migrate across the electrolyte to the cathode. To properly function, the electrolyte must be a good conductor of sodium ions, be a poor conductor of electrons, physically separate the anode and cathode materials, and have sufficient structural integrity to withstand the harsh environmental conditions during operation. These solid electrolyte devices are usually operated at high temperatures (around 300 degrees Centigrade) and materials of the electrodes are corrosive and very reactive at these temperatures.

The electrolyte is fabricated into tubes, discs, or other shapes from a sodium-conducting ceramic, such as BASE or NASICON. In current sodium ion conducting solid-state electrolyte designs, the structural integrity of each cell electrolyte depends solely on the solid electrolyte material itself. The wall thickness of the electrolyte must be sufficiently thick, and the ceramic be sufficiently strong for the electrolyte to be self-supporting and to maintain its physical integrity. Typically, wall thickness are at least 1 mm, usually between about 1 and 2 mm, and fabrication requires prolonged sintering and conversion steps at high temperatures. This results in high costs of materials and processing.

A problem with higher wall thicknesses is a lowering of performance due to a higher area specific resistance (ASR). In general, ASR can be reduced by reducing the thickness. A significant reduction of the electrolyte thickness should reduce the ASR, and result in significant performance improvement. Although there is great incentive to reduce electrolyte thickness, this inherently reduces physical integrity. The advantages of a thin wall thickness can be seen by referring to the graph in FIG. 1, which shows ASR of the sodium ion conductor electrolyte material as function of temperature and thickness. This shows that a reduction of thickness results in significant reduction of ASR.

A problem, though, in reducing wall thickness is that the materials of the electrolyte are ceramics, and even high-performance ceramics generally have the inherent problem of relatively low mechanical strength when compared to metals. Accordingly, an electrolyte-supported cell structure exhibits low fracture strength, which aggravates safety issues from cracking and failure of the ceramic electrolyte.

Accordingly, in a ceramic electrolyte design, the selected thickness is a tradeoff between performance (low ASR) and safety (physical integrity). Currently, a thin electrolyte with a wall thickness less than 500 micrometers is very difficult to manufacture, and, even if it can be made, long-term structural and mechanical stability cannot be ensured. For this reason, electrolytes in practical applications must have higher thickness and cannot approach the low ASR values illustrated in FIG. 1.

### SUMMARY

Disclosed is a supported electrolyte structure, which is referred herein as a Porous-Metal Supported Ceramic-Electrolyte (PMSCE). The PMSCE provides an electrolyte structure for energy storage batteries, thermoelectric converters, and applications that require a sodium-ion conducting electrolyte. The PMSCE comprises a thin film sodium ion conducting electrolyte supported on a porous metal substrate. Physical integrity is provided by the porous support, accordingly the sodium ion conducting layer can be much thinner than would be required if the electrolyte ceramic itself was self-supporting.

Referring to FIG. 2, which illustrates the thin film solid-state electrolyte architecture of the PMSCE 11. A supported dense film of electrolyte 13 of a sodium ion conducting ceramic electrolyte is supported as a thin layer upon a porous metal support 15 having open pores 21 infiltrating a metal support structure 23.

The electrolyte material of the film 13 is any suitable sodium ion conducting ceramic that can be formed as a thin film upon the support. It is understood that where reference is made to “sodium ion conducting” ceramics, that any alkali-metal can be substituted in place of sodium. Accordingly, suitable ceramics include conductors of Li, Na, K, Rb, Cs, and Fr ions. Sodium-ion (Nat) conducting ceramics in particular are suitable because of their stability and wide availability.

Examples of suitable materials for the electrolyte include alkali-metal-beta- and beta″-alumina and gallate polycrystalline ceramics. These materials are disclosed in U.S. Pat. No. 6,632,763, which is hereby incorporated by reference. Included in suitable materials are β″-Al₂O₃ (Na₂O.(5˜7)Al₂O₃) with a rhombohedral crystal structure (R3m) composed of alternating closely-packed slabs of Al₂O₃ and layers with mobile sodium ions.

Other suitable materials include NASICON-type materials. These include materials with the general formula NaM₂(PO₄)₃, where M is a tetravalent cation. NASICON materials are disclosed in U.S. Pat. No. 4,526,844, which is hereby incorporated by reference. A suitable NASICON material is Na₃Zr₂Si₂PO₁₂.

A function of the support is to provide physical support for the thin electrolyte at the temperatures to which the PMSCE is subjected. Accordingly, desired properties include strength and lack of brittleness, which are properties inherently provided by porous metals. Other porous materials that provide the same or similar properties as metals are also contemplated.

Any suitable porous metal for the support is contemplated. Suitable materials are commercially available. These materials are generally formed by sintering metal powders using various processes, and may be, for example, aluminum, stainless steel, or mild steel. Materials where thermal expansion coefficients match with that of the sodium ion conducting solid electrolytes are suitable, such as mild steel and stainless steel 400 series. Other metals and alloys are also contemplated, such as porous metals from one or a mixture of metal powders, such as, stainless steel, bronze, nickel, and nickel based alloys, titanium, copper aluminum or precious metals.

The porous support is manufactured by any suitable method, including conventional process such as sintering by axial compression, gravity sintering, rolling and sintering, and isostatic compaction and sintering. Porosity of the support should be sufficient to allow passage of electrode fluid, and to allow exposure of electrolyte surface at the interface of the porous support and electrolyte film.

The porous metal support is made into a suitable shape. Since the electrolyte is thin, the shape and dimensions of the PMSCE are generally essentially the same as the support. In general the PMSCE is contemplated to be a replacement of solid ceramic electrolytes in current designs. Accordingly, the PMSCE can be manufactured into the same shapes that known solid ceramic electrolytes are made, such as tubes, discs, complex-shape cross-sectional cylinders and tubes, and planar shapes of simple or complex geometry.

The electrolyte membrane or film can be formed upon the porous support by various deposition approaches, including but not limited to atmospheric plasma spray (APS), vacuum or low-pressure plasma spray, electric or wire arc spray, high velocity oxygen fuel (HVOF) spray, atomic layer deposition (ALD), chemical vapor deposition (CVD), and physical vapor deposition (PVD). Upon deposition, a thin but dense film of sodium ion conducting layer is developed with its thickness as thin as several micrometers. Thickness may be less than about 500 micrometers or as thin as or less than 400, 300, 200, or 100 micrometers, as low as 10 micrometers.

The deposition process is suitably operated at low temperatures. Unlike fabrication of a self-supporting ceramic electrolyte body, forming the film doesn't require prolonged sintering steps at high temperatures (such as 1650° C).

The electrolyte film should be continuous over the region of the PMSCE that separates the liquid electrodes, and the density of the film should be high enough to avoid any porosity that allows passage and mixture of anode and cathode fluids. Any density and thickness of the film that ensures a continuous film with this lack of porosity is suitable.

Referring to again FIG. 1, an exemplary thickness of the electrolyte film of 500 micrometers has an ASR proportionally less than the 1 mm (1000 micrometers) thick conventional electrolytes. Reduction of the film to as low as 100 or 10 micrometers, would be expected to proportionally reduce the ASR further.

Since the support is a metal, is electrically conductive, and is porous, it is expected that the support has a small or negligible contribution to the ASR. Accordingly, the porous support can be made structurally thick and strong without materially reducing the ASR. Accordingly, unlike with solid ceramic supported electrolytes, with the PMSCE performance can be optimized and need not be compromised to ensure physical integrity.

Referring again to FIG. 2, the thin film electrolyte 13 has two active electrolyte surfaces, a first or inner surface 17 proximate to the porous support and a second or outer surface 19 distal from the porous support. Electrode fluid passes through pores 21 of the porous support, and contacts exposed surfaces 17 in the pores where the inner electrolyte surface is exposed within the pores of the support. The outer surface 19 contacts the other electrode. Sodium ions travel through the electrolyte film 13, between electrodes at surfaces 17 and 21, while passage of the electrode fluids through the film 13 is blocked.

The PMSCE can be applied to any suitable electrochemical device that requires a solid sodium-conducting electrolyte contacted with a fluid (liquid or gas). Specific examples include batteries where the PMSCE contacts liquid anode and liquid cathode, and an alkali-metal thermal to electric converter, where the PMSCE contacts alkali-metal liquid and vapor.

Sodium batteries are described in the following United States patent documents, all of which are incorporated by reference; 2013/0004828, 2012/0040230, 2010/0068610, U.S. Pat. Nos. 6,902,842, 6,329,099, 6,245,455, 5,763,117, 5,538,808, 5,196,277, 5,053,294, 4,999,262, 4,945,013, 4,921,766, 3,918,992. Sodium batteries comprise a liquid metal anode and a liquid cathode that are separated by an electrolyte structure. In the references, the electrolyte structure in these references is a solid ceramic material, which can be replaced by an appropriately dimensioned PMSCE.

In a sodium-sulfur battery cell, the anode comprises sodium, and the cathode comprises sulfur. During discharge, sodium gives off an electron and the sodium ion migrates from the anode reservoir through the beta alumina separator into the cathode reservoir.

In a sodium-nickel/NaCl battery cell, the anode comprises sodium, and the cathode comprises nickel/NaCl. During charging, chloride ions are released from sodium chloride and combined with nickel to form nickel chloride. These sodium ions then migrate from the cathode reservoir through the electrolyte into the anode reservoir. During discharge, the reverse chemical reaction occurs and sodium ions migrate from the anode reservoir through the beta alumina separator into the cathode reservoir.

In conventional sodium battery cell designs there is construction to limit the flow and direct reaction of anode and cathode fluids in the event of an electrolyte failure. These typically involve flow restrictors and safety tubes. In the current design, the porous support of the PMSCE can also function as a flow restrictor. This control may also eliminate the need for a safety tube.

For a battery cell, exemplary liquid anodes include any of the liquid alkali-metals. Known liquid sodium anodes are suitable.

For a battery cell, any suitable liquid cathode material is contemplated. Exemplary liquid cathodes include any of the known liquid cathode materials, including, for example, liquid sulfur, nickel/NaCl, and sulfur/aluminum chloride/sodium chloride.

The battery cell can be operated at a temperature from 110˜350° C. In convectional designs, the operating temperature is usually around 300° C. A high temperature is chosen to lower the ASR to a practical value. In contrast, by using a PMSCE with a low ASR thin-film electrolyte, the ASR is low enough at more modest temperatures to allow for practical low-temperature operation.

The operating temperature is also dictated by the melting point of the electrodes. Sulfur/polysulfides melt at about 290° C., so a sulfur-cathode cell must be operated above this temperature. However, for cathodes that melt at lower temperatures, the cell can be operated at a much lower temperature that is still above the melting point of the electrodes. Because of the inherently low ASR of the PMSCE electrolyte, the low operating temperature does not seriously compromise performance. An example of a low temperature melting cathode material is sulfur/aluminum chloride/sodium chloride (S/AlCl3/NaCl), which has been operated at a temperature of 175° C. (J. J. Auborn and S. M. Granstaff. “Sodium-Sulfur-Aluminum Chloride Cells”, Journal of Energy, Vol. 6, No. 2 (1982), pp. 86-90) Another example, is disclosed in ECS Transactions, 16 (49) 189-201 (2009) 10.1149/1.3159323, where a Na/β″-alumina/S(IV) cell in chloroaluminate melt is operated to a temperature as low as 120° C. Further advances are expected to allow operation to just above the melting point of the sodium anode (98° C.). Accordingly it is contemplated to operate a cell using a low-melting cathode to as low as the low 100 range, such as at 110° C.

In a battery cell, the inner and outer surface can contact either the fluid anode, or the fluid cathode. Which surface contacts the anode or cathode involves several factors. For example, since it is less expensive to coat an outer surface of a tube, the electrolyte film would be more conveniently coated upon the outer surface of a tubular support, and the outer surface would contact whatever electrode fluid the device design dictates. In addition, the inner surfaces along with the porous support may contact the fluid electrode with the best compatibility with the porous metal of the support. Other considerations might include wetability and ability of the liquid electrode material to pass through or infiltrate the porous support.

Referring to FIG. 10, which is a schematic of an exemplary application of a PMSCE in a liquid sodium battery cell, a liquid sodium anode 101 is contained within a tubular PMSCE structure 103. The PMSCE comprises a porous metal support 113, and a dense film sodium-ion conducting electrolyte 115. Surrounding the PMSCE structure is a suitable molten cathode 105. The molten cathode is contained within a case 107 that encloses the entire cell. Suitable current collectors and electrical connections 109, and seals 110 are also provided. In an alternate construction, the porous support of the PMSCE may also be a current collector, as shown by the phantom connection 111.

An alkali metal thermal to electric converter (AMTEC) is described in U.S. Pat. Nos. 3,404,036; 3,458,356; 3,535,163; and 4,049,877; which are incorporated by reference. It is a thermally regenerative electrochemical device for the direct conversion of heat to electrical energy. In the AMTEC sodium is driven around a closed thermodynamic cycle between a high temperature heat reservoir and a cooler reservoir at the heat rejection temperature. Sodium ion conduction occurs between a high pressure and a low pressure region on either side of a solid sodium ion conducting electrolyte, which can be the PMSCE construction of a thin film electrolyte supported upon a porous metal support. Electrochemical oxidation of neutral sodium at the anode leads to sodium ions which traverse the solid electrolyte and electrons which travel from the anode through an external circuit where they perform electrical work, to the low pressure cathode, where they recombine with the ions to produce low pressure sodium gas. The sodium gas generated at the cathode then travels to a condenser at the heat rejection temperature where liquid sodium reforms.

Referring to FIG. 11, illustrated is a schematic of an exemplary AMTEC, a PMSCE structure 201 is disposed between a cathode 203 and an anode 205. The anode-PMSCE-cathode structure separates a high pressure sodium vapor chamber 207 from a low pressure sodium vapor chamber 209, with the anode 205 in the high pressure chamber and the cathode 203 in the low pressure chamber. Sodium vapor from the low pressure chamber is condensed by a condenser 211 to a liquid and releases heat to a heat sink. The liquid sodium is conveyed by a pump 213 to a higher pressure toward the high pressure chamber 207 where it passes through an evaporator 209 and evaporates into sodium vapor and absorbs heat. Sodium ions migrate through the PMSCE from the anode 205 to the cathode 203. The PMSCE comprises a porous metal support 215, and a thin film sodium-ion conducting ceramic electrolyte 217. The porous support may also function as an electrode as shown, or the electrode may be provided by a separate structure, as shown in phantom.

### BRIEF DESCRIPTION OF DRAWINGS

FIG. 1 is a graph showing Area Specific Resistance of a Sodium Ion Conductor Electrolyte as a Function of Temperature and Thickness

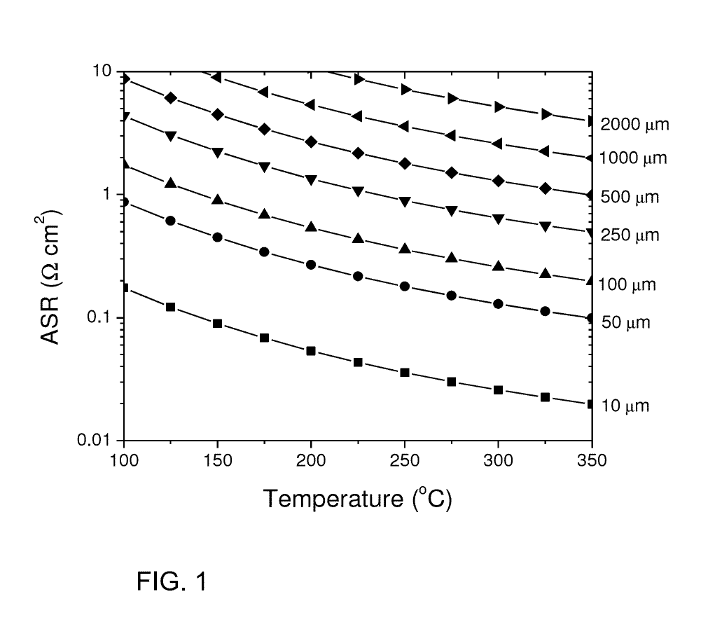

FIG. 2 is a schematic diagram showing Thin Sodium Ion Conductor Electrolyte Supported on a Porous Metal Support

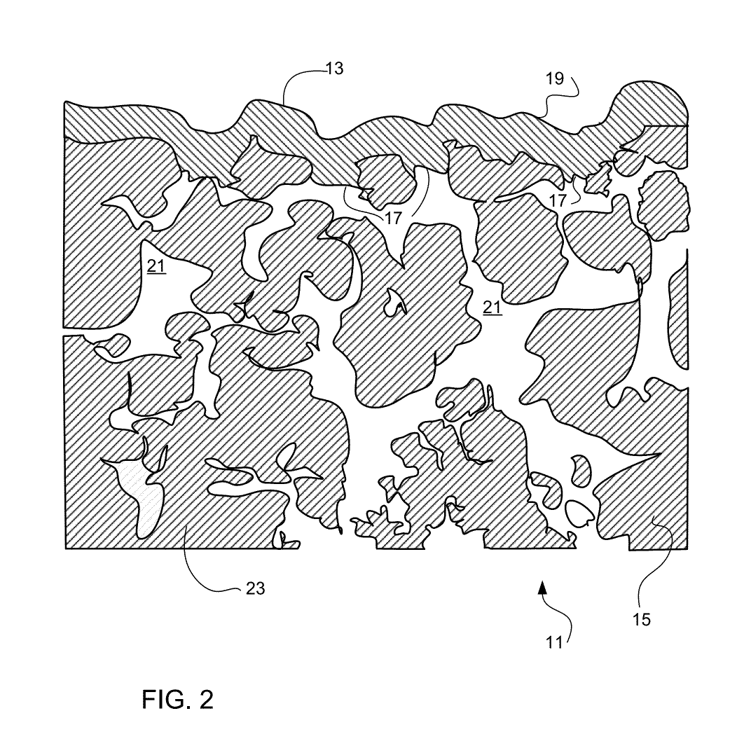

FIG. 3A and FIG. 3B show Photographs of Thin Film Sodium Ion Conducting Layers Deposited on Porous Metal Supports (PMSCE): 1.0˜1.5-inch Diameter Disks (A) and 10-inch Long Tube (B)

FIG. 4 is a photograph showing Cross-Section of Thin Film Sodium Ion Conducting Layer Deposited on a Porous Metal Support

FIG. 5 is a graph showing X-ray Diffraction Spectroscopy on Sodium-Beta-Alumina Layer Deposited on a Porous Metal Support

FIG. 6 is a schematic diagram showing The four-point probe method for measurement of ionic conductivity of the sodium-conducting solid electrolyte

FIGS. 7A and 7B—The Thermal Cycling Temperature Profile (A) and a Photograph (B) of the Thin Film Sodium-Beta″-Alumina Layer Deposited on a Porous Metal Support (Left) Compared to the Same Sample after Ten Thermal Cycles between 50° C. and 350° C. in Nitrogen (Right)

FIG. 8 is a graph showing Mechanical Strength of the Thin Film Sodium-Beta″-Alumina Layer Deposited on a Porous Metal Support (PMSCE) measured by a Ring-on-Ring Test based on the ASTM C1499

FIG. 9—A Photograph of the Thin Film Sodium-Beta″-Alumina Layer Deposited on a Porous Metal Support, Showing No Crack after Applying More Than 500 MPa during the Ring-on-Ring Test based on the ASTM C1499.

FIG. 10 is a schematic diagram of a sodium battery cell.

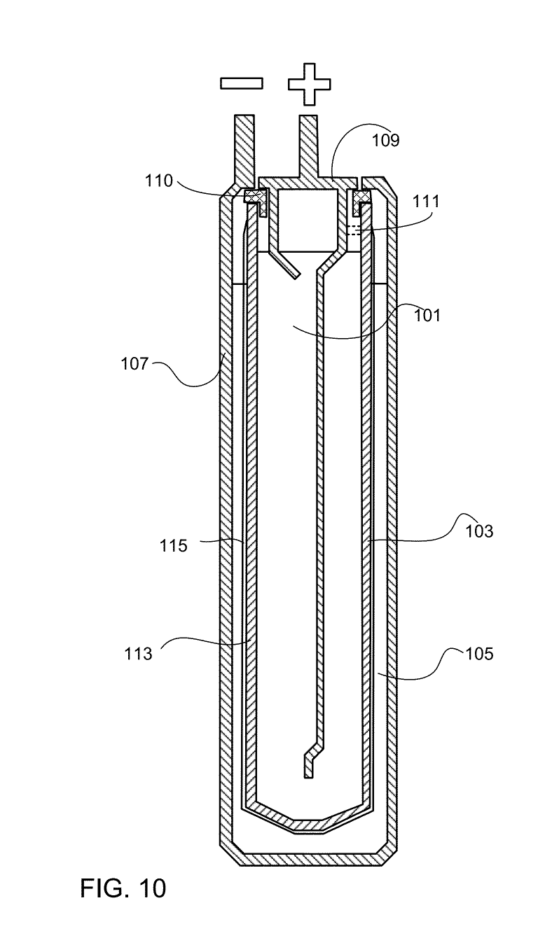

FIG. 11 is a schematic diagram of an alkali metal thermal to electric converter.

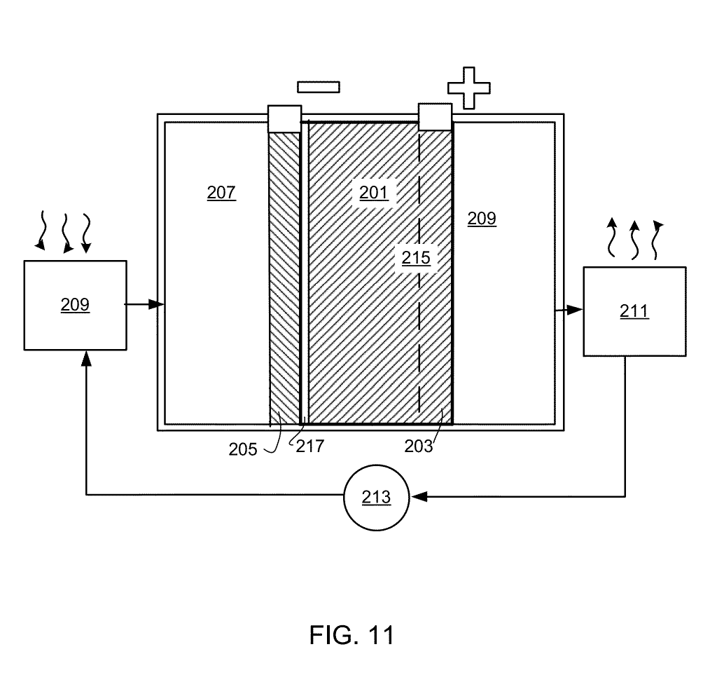

### DETAILED DESCRIPTION

### EXAMPLE 1

Na-β″-Al₂O₃ powders were synthesized using the solid-state reaction method. It consisted of mixing of raw materials, ball-milling, drying, and calcination. The raw materials were boehmite (alumina hydroxide, CATAPAL® 200, from Sasol North America) as a source of alumina, sodium carbonate monohydrate (Na₂CO₃.H₂O from Alfa Aesar) as a source of sodium, and magnesium oxide (MgO from Alfa Aesar) as a β″-phase-stabilizing dopant. The raw materials were mixed to make a composition of 8.5% Na₂O, 4.5% MgO, and balance Al₂O₃ (wt. %). The powder mixture was ball-milled, dried, and calcined at 1250° C.

The calcined Na-β″-Al₂O₃ powder was spray-dried to add flowability. The calcined powder was dispersed in deionized water to form aqueous slurry. A small amount of PMMA(polymethyl methacrylate)-based dispersant (Dolapix CE64, Zschimmer & Schwarz) was added to maintain good suspension during the spray drying process. The powder slurry was ball-milled for mixing and grinding. The ball-milled powder slurry was processed in an industrial spray dryer with a rotary atomizer. The inlet and outlet temperatures were 270° C. and 100° C., respectively. The spray-dried Na-β″-Al₂O₃ powders were screened using 325 and 635 meshes to collect powders in the size range of 20 to 45 μm. The collected powder (20˜45 μm size) was moved into plastic bottles and stored in a freezer.

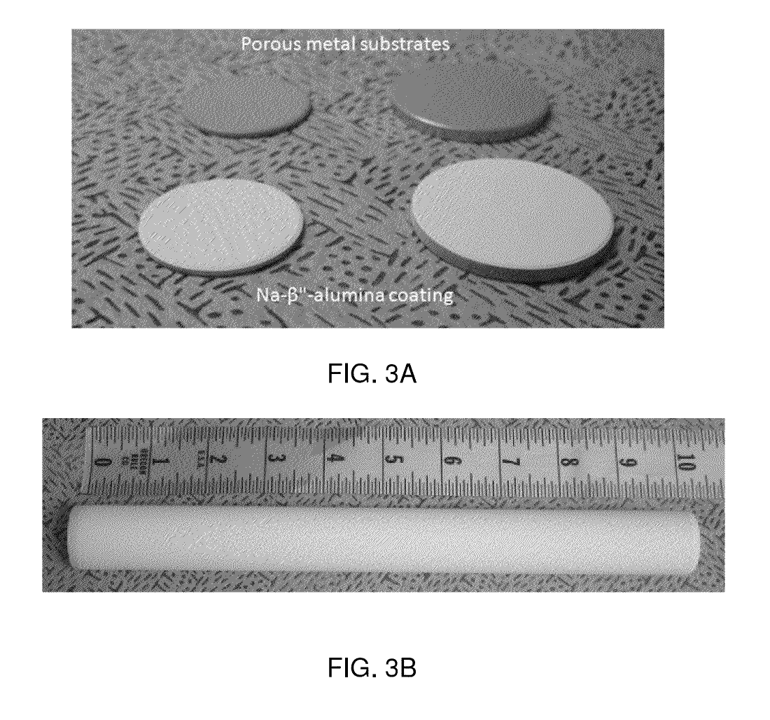

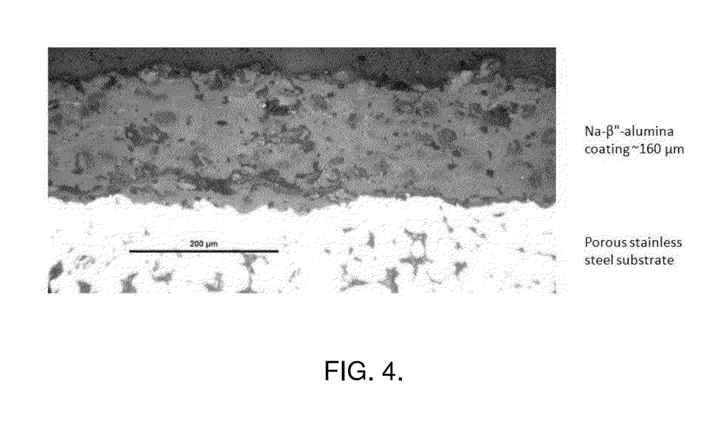

The synthesized Na-β″-Al₂O₃ powder was deposited on porous stainless steel disks by atmospheric plasma spray (APS) coating. FIG. 3 shows the substrate disks (1.2-inch 316L SS disk with 2.0 micrometer pore grade and 1.5-inch 430 SS disk with 0.1 micrometer pore grade) and the thin film of Na-β″-Al₂O₃ layer deposited on these substrates by atmospheric plasma spray. FIG. 4 shows a cross-section of the deposited Na-β″-Al₂O₃ layer which is dense and has a thickness of approximately 160 micrometers.

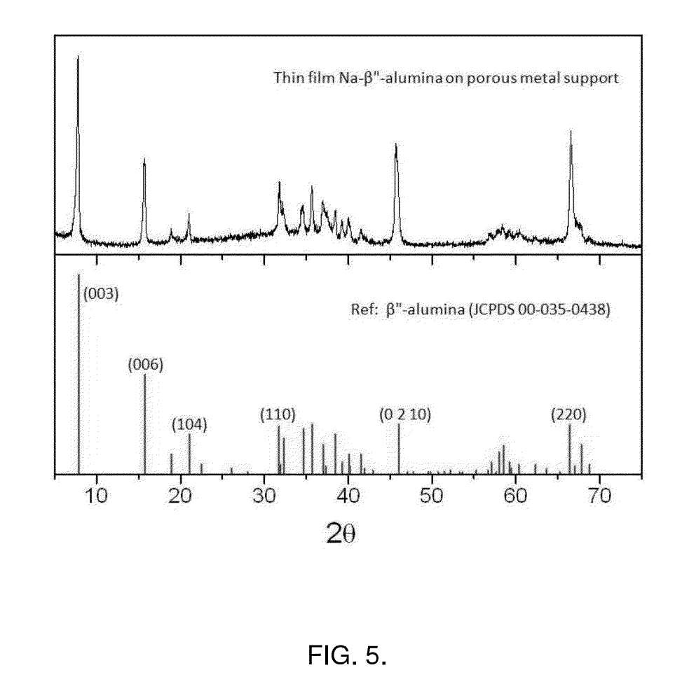

FIG. 5 shows an X-ray diffraction pattern of the deposited Na-β″-Al₂O₃ layer in comparison to the reference β″-Al₂O₃ XRD data (JCPDS No. 00-035-0438 for Na_{1.67}Mg_{0.67}Al_{10.33}O₁₇). The strong peak at ˜7.8° (2θ) is unique for the β″-Al₂O₃ and β-Al₂O₃ structures. The presence of this peak is an indication that the β″-Al₂O₃ and/or β-Al₂O₃ structures exist. The distinction between the β″-Al₂O₃ and β-Al₂O₃ structures can be done with the peaks at 30° to 50°. The strong peak at ˜46° is an indication of the presence of the β″-Al₂O₃ structure. The absence of peaks at ˜33° and ˜44 is an indication that the β-Al₂O₃ phase does not exist. Both the α- and γ-alumina phases do not exist in the synthesized powder. It is apparent from this XRD pattern that the deposited film is highly pure Na-β″-Al₂O₃.

### EXAMPLE 2

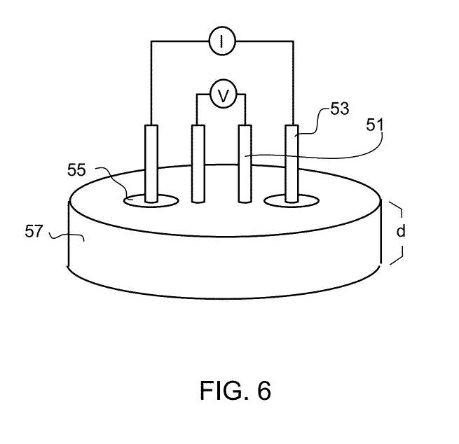

Ionic conductivity was measured using a four-point probe device schematically described in FIG. 6. This four-point probe method measures conductivity of solid ionic conductors in a way similar to measurement of sheet resistivity by the so-called van der Pauw technique (see Rev. Sci. Instrum. 76 (2005) 033907). The resistance is obtained by measuring the voltage (V) between two inner probes 51 while flowing an AC electrical current (I) between two outer probes 53 (mounted on a layer of salt 55 for contact aid). This measurement works well when the thickness (d) of the sample 57 is relatively small. The resistivity (ρ), which is the reciprocal of conductivity (σ), is calculated from the measured voltage and current together with a geometrical correction factor (f). In the case of a thin film disc sample, the following formula is used.

$$ρ = \frac{1}{σ} = \frac{π \cdot d}{ln ( 2 )} \cdot \frac{V}{I} \cdot f \qquad ( 1 )$$

The geometrical correction factor (f) for a finite-diameter disk sample can be approximately 0.85. For an infinite-diameter disc, the correction factor becomes unity.

The conductivity measurement system was built using a Sweep Function Generator (Waketek Model 180) connected to a 15 kΩ resistor in series to generate the AC current. The frequency was maintained constant at 1 kHz, and the current was measured using a BK Test Bench (Model 388A). The voltage was measured using a Keithley 2000 multimeter at a current of approximately 40 μA. A K-type thermocouple was placed near the probes and the temperature was measured using an Omega thermometer (Model HH501 DK). The spacing between the electrode probes was 5 mm.

In solid-state ion conductor samples, the measurement of ionic conductivity is often difficult due to relatively high contact resistances between the leads and the sample surface. For this reason, the probes need contact aids to allow for a measurable current flow. Wetting the outer probes by a thin film of salt provides good contact between the probes and the sample surface. The thin film contact aid near the probe needs to be in the liquid state to maintain the wetting effect. For sodium ion conductors, a eutectic salt of NaNO₃+NaNO₂ works well as it has a melting point of approximately 240° C. The conductivity can be measured in the temperature range of 270-450° C. The thin film contact aid was applied only to the surface contact points of outer probes, as shown in FIG. 6. Therefore any conduction through the contact aid is localized near the probes and would not affect the accuracy of measured conductivity values.

The four-point probe method was applied to measure sodium ionic conductivity of two different Na-β″-Al₂O₃ coated disk samples. The coating thickness of two samples is approximately 150 μm and 200 μm, respectively. Area-specific resistance (ASR) was obtained from the conductivity and the coating thickness. The results are shown in Table 1.

TABLE 1
Sodium ionic conductivity of the plasma-
spray coated Na-β″-alumina

| | | | | Area-Specific |
|---|---|---|---|---|
| | Temperature | Resistance | Conductivity | Resistance |
| | (° C.) | (Ω) | (S/cm) | (Ω · cm²) |
| Coating sample | 287 | 305.25 | 0.0482 | 0.3113 |
| 1 (150 μm | 308 | 160.82 | 0.0915 | 0.1640 |
| thickness) | 328 | 121.70 | 0.1209 | 0.1241 |
| | 346 | 96.98 | 0.1517 | 0.0989 |
| | 348 | 86.13 | 0.1708 | 0.0878 |
| Coating sample | 291 | 97.94 | 0.1126 | 0.1776 |
| 2 (200 μm | 313 | 78.62 | 0.1403 | 0.1425 |
| thickness) | 333 | 69.43 | 0.1589 | 0.1259 |
| | 353 | 34.96 | 0.3156 | 0.0634 |

The ASR at ˜300° C. is approximately 0.16˜0.17 ·cm² in both samples. For comparison, the highest conductivity of the state-of-the-art Na-β″-Al₂O₃ prepared by the conventional sintering methods is 0.36 S/cm at 300° C. (see J. Power Sources 195 (2010) 2431-2442). Assuming Na-β″-Al₂O₃ tubes or disks prepared the conventional sintering methods have a thickness of 1.5 mm, their ASR would be 0.42 Ω·cm² at 300° C. The ASR of the PMSCE of this example is approximately 40% of the current state-of-the-art Na-β″-Al₂O₃ technology. With an optimized thermal spray coating process, the coating structure (especially the direction of conduction planes in Na-β″-Al₂O₃) may be improved and the reduction in ASR can be more significant.

The low ASR provides opportunities for higher performance at the same temperature range as those of the current state-of-the-art Na-ion conductor solid electrolyte batteries or thermoelectric converters. It also provides an opportunity of operating the sodium batteries at lower temperatures, down to 110˜120° C. in principle (because sodium melts at 98° C.), if a compatible cathode material is used.

### EXAMPLE 3

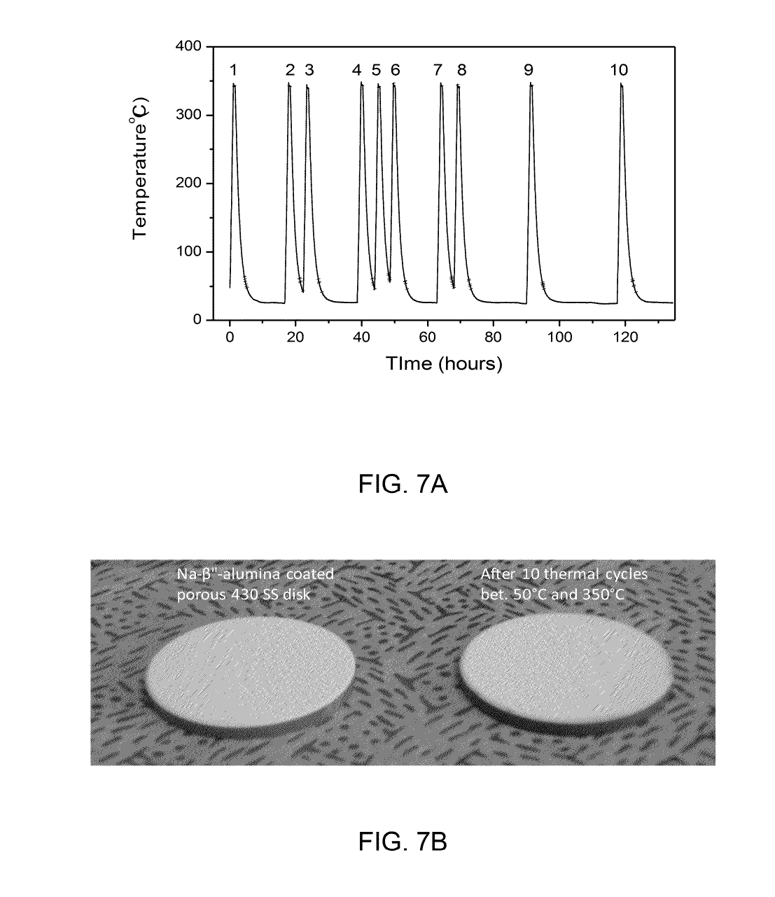

The coated disks prepared as described in Example 1 were subject to repeated thermal cycles. FIG. 7 shows the temperature profile during a total of ten thermal cycles between 50° C. (or room temperature) and 350° C. The photograph reveals no crack and no delamination of the coated Na-β″-Al₂O₃ thin film layer after the ten thermal cycles. This assures that thin film sodium conducting solid electrolyte is stable.

To maximize the thermomechanical stability, the coefficient of thermal expansion (CTE) can be matched as close as possible between the substrate metal and the coated sodium conducting solid electrolyte thin film. Table 2 is a comparison chart of several metals for their CTEs and the Na-β″-Al₂O₃'s CTE. The metal with relatively high CTEs (e.g. 316L SS) can still be used as the substrate, because the CTE of porous metals is usually lower than the CTE of dense body. All these commodity metals can therefore be considered as the coating substrates.

TABLE 2
Comparison of the coefficients of thermal expansion (CTE)

| Material | CTE (ppm/K) |
|---|---|
| Beta″-alumina | 7.5 |
| 316L SS | 16.5 |
| 430 SS | 10.4 |
| Hastelloy ® | 14.0 |
| Mild steel | 12.8 |
| Titanium | 6.5 |

### EXAMPLE 4

The coated disks prepared as described in Example 1 and those which underwent ten thermal cycles as described in Example 3 were tested for their mechanical strength. The conventional Na-β″-Al₂O₃ has the maximum fracture strength of approximately 200 MPa (see J. Power Sources 195 (2010) 2431-2442).

The mechanical strength of ceramic disk specimens can be determined by flexure strength measurement methods. A preferred method is the ring-on-ring equibiaxial flexure test such as the ASTM C-1499. In this method, a metal ball or a metal ring with diameter D_{L} is used to apply a load F on top of the test specimen which is supported on another metal ring of diameter D_{S}. The formula for the equibiaxial strength, σ_{f}, of a circular plate in units of MPa is (Ref. ASTM C-1499-09)

$${σ}_{f} = \frac{3 F}{2 π {h}^{2}} [ ( 1 - v ) \frac{{D}_{{S}^{2}} - {D}_{{L}^{2}}}{2 {D}^{2}} + ( 1 + v ) ln \frac{{D}_{s}}{{D}_{L}} ] \qquad ( 2 )$$

where:

F=the breaking load in units of N

ν=Poisson's ratio

h=the test specimen thickness in units of mm

D=the test specimen diameter in units of mm

D_{S}=the support ring diameter in units of mm

D_{L}=the load ring diameter in units of mm.

The strength of a circular plate (disk) made from layers with significantly different elastic constants can be determined from loading between concentric rings if the appropriate stress solution, elastic constants, and assumptions are used. For a bilayer disk with a substrate thickness of h₁ and a coated thickness of h₂, the strength of the coated layer (σ₂) can be expressed as (Ref. ASTM C-1499-09, Compos. Sci. Tech. 67 (2007) 278-285);

$${σ}_{2} = \frac{- {E}_{2} ( h - h ) F}{4 π ( 1 - {v}_{2} ) Δ} [ ln \frac{{D}_{S}}{{D}_{L}} + \frac{( 1 - v ) ( {D}_{{S}^{2}} - {D}_{{L}^{2}} )}{2 ( 1 + v ) {D}^{2}} ] \qquad ( 3 )$$

with

$$\begin{matrix}h = \frac{\frac{{E}_{1} {h}_{1}}{1 - {v}_{{1}^{2}}} ( \frac{{h}_{1}}{2} ) + \frac{{E}_{2} {h}_{2}}{1 - {v}_{{2}^{2}}} ( {h}_{1} + \frac{{h}_{2}}{2} )}{\frac{{E}_{1} {h}_{1}}{1 - {v}_{{1}^{2}}} + \frac{{E}_{2} {h}_{2}}{1 - {v}_{{2}^{2}}}} & ( 4 ) \\ Δ = \frac{{E}_{1} {h}_{1}}{1 - {v}_{{1}^{2}}} ( \frac{{h}_{{1}^{2}}}{3} - \frac{{h}_{1} h}{2} ) + \frac{{E}_{2} {h}_{2}}{1 - {v}_{{2}^{2}}} ( {h}_{{1}^{2}} + {h}_{1} {h}_{2} + \frac{{h}_{{2}^{2}}}{3} - ( {h}_{1} + \frac{{h}_{2}}{2} ) h ) & ( 5 ) \\ v = \frac{1}{h} ( {v}_{1} {h}_{1} + {v}_{2} {h}_{2} ) & ( 6 ) \\ h = {h}_{1} + {h}_{2} & ( 7 )\end{matrix}$$

where:

E₁=Young's modulus of the substrate in units of MPa

E₂=Young's modulus of the coated layer in units of Mpa

ν=Poisson's ratio of the substrate

ν₂=Poisson's ratio of the coated layer

Eqns (3) through (7) were used to calculate the strength of Na-β″-Al₂O₃ coated layers on porous metal disk substrates. The parameters used in the calculation are in Table 3.

TABLE 3
Parameters used for calculation of the strength
of Na-β″-Al₂O₃ coated layers

| Parameter | Value | | Source |
|---|---|---|---|
| D_{L} - load ring diameter | 7.6 | mm | Measured |
| Dₛ - support ring diameter | 19.0 | mm | Measured |
| D - test specimen diameter | 30.0 | mm | Measured |
| h₁ - thickness of the substrate | 1.67 | mm | Measured |
| h₂ - thickness of the coated later | 0.15 | mm | Measured |
| | | | (approximate) |
| E₁ - Young's modulus of the substrate | 35,000 | MPa | Vendor |
| | | | specification |
| E₂ - Young's modulus of the coated | 210,000 | MPa | Literature ^{†} |
| layer | | | |

| | | |
|---|---|---|
| v₁ - Poisson's ratio of the substrate | 0.3 | Literature ^{‡} |
| v₂ - Poisson's ratio of the coated layer | 0.25 | Literature ^{†} |

^{†} J. L. Sudworth and A. R. Tilley, The Sodium Sulfur Battery, Chapman and Hall, New York, 1985.
^{‡} W. D. Callister, Jr., Materials Science and Engineering - An Introduction, 5^{th} edition, John Wiley & Sons, 2000.

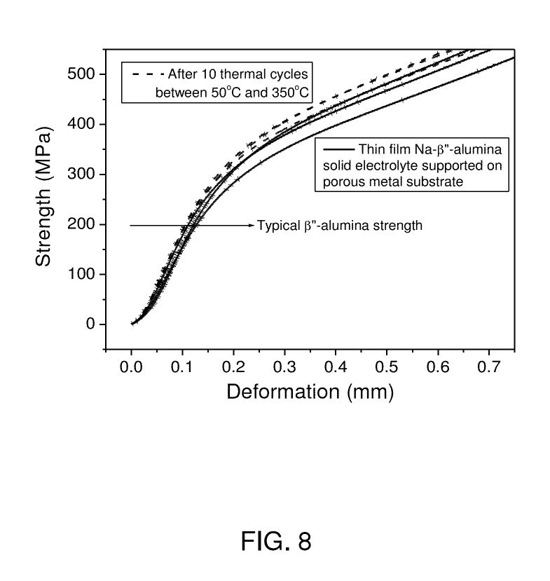

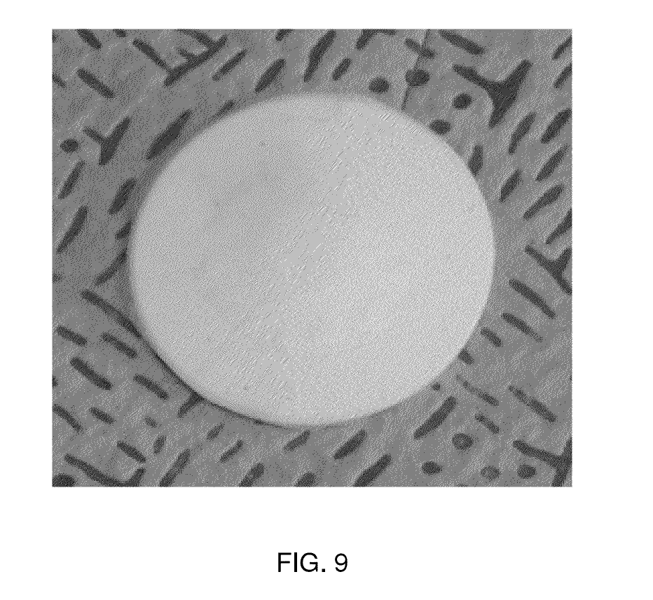

The resulting strength-deformation curves are shown in FIG. 8. Three Na-β″-Al₂O₃ coated specimens (not thermally cycled) were tested. Three other Na-β″-Al₂O₃ coated specimens were thermally cycled ten times as described in Example 3 and were tested with the same method. Up to over 500 MPa, none of the six specimens fractured. The tests stopped at this strength, because the specimens deformed noticeably, although not fractured, that may affect the reliability of test data at a higher load. Due to the nature of the metal substrate, the specimens show the typical elastic-plastic deformation behavior rather than fracturing. This test reveals that such a thin film ceramic layer (sodium conducting solid electrolyte) can sustain the intense stress without being fractured because it is supported by the stronger metal substrate. Even deformation did not result in any crack of the coated layer as shown in the photograph of one of the tested specimens (FIG. 9). The same stress (500 MPa) will easily fracture the conventional self-supported sodium conducting solid electrolytes. It demonstrates the significantly enhanced mechanical strength of the sodium conducting solid electrolyte cell design.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

1. A battery cell comprising a liquid sodium anode, and a liquid cathode, the anode and cathode separated by an electrolyte structure comprising a porous metal support and a thin film of sodium ion conducting solid electrolyte supported on the support,
the sodium-ion conducting solid electrolyte having
a first surface proximate to the porous support with the first surface contacting the liquid sodium anode where the liquid sodium passes through porosity of the porous support,
and a second surface distal from the porous support contacting the liquid of the liquid cathode.

2. A battery cell comprising a liquid sodium anode, and a liquid cathode, the anode and cathode separated by an electrolyte structure comprising a porous metal support and a thin film of sodium ion conducting solid electrolyte supported on the support,
the sodium-ion conducting solid electrolyte having
a first surface proximate to the porous support with the first surface contacting the liquid cathode where the liquid of the cathode passes through porosity of the porous support,
and a second surface distal from the porous support contacting the liquid of the liquid anode.

3. A battery cell comprising a liquid anode, and a liquid cathode separated by an electrolyte structure comprising a porous metal support and a thin dense film of alkali-metal ion conducting solid electrolyte supported on the porous metal support.

4. A battery cell as in claim 3 wherein the solid electrolyte is a conductor of Li, Na, K, Rb, Cs, or Fr ions.

5. A battery cell as in claim 3 wherein the thin dense film has a thickness between 10 and 1000 micrometers.

6. A battery cell as in claim 3 wherein the thin dense film 3 has a thickness between 100 and 500 micrometers.

7. A battery cell as in claim 3 wherein the porous support comprises one or more of mild steel, stainless steel, nickel alloy, aluminum, and titanium.

8. A battery cell as in claim 3 wherein the thin film of sodium ion conducting solid electrolyte comprising β″-Al₂O₃(Na₂O.(5˜7)Al₂O₃) with a rhombohedral crystal structure (R3m) composed of alternating closely-packed slabs of Al₂O₃ and layers with mobile sodium ions.

9. A battery cell as in claim 3 wherein the thin film of sodium ion conducting solid electrolyte comprising NASICON (Na₃Zr₂Si₂PO₁₂).

10. A battery cell as in claim 3 wherein the sodium ion conducting solid-state electrolyte layer is formed by one or more of the deposition approaches including atmospheric plasma spray (APS), vacuum or low-pressure plasma spray, electric or wire arc spray, high velocity oxygen fuel (HVOF) spray, atomic layer deposition (ALD), chemical vapor deposition (CVD), and physical vapor deposition (PVD).

11. A battery cell as in claim 3 wherein the anode comprises liquid sodium.

12. A battery cell as in claim 3 wherein the cathode comprises liquid sulfur, or liquid nickel/NaCl, or liquid sulfur/aluminum chloride/sodium chloride.

13. A battery cell as in claim 3 wherein the electrolyte structure is tubular, or is disk-type, or of complex cylindrical geometry cylindrical, or is planar.

14. A battery cell as in claim 3 wherein the anode is adjacent to the to the porous support and the cathode is adjacent to the thin dense film.

15. A battery cell as in claim 3 wherein the cathode is adjacent to the to the porous support and the anode is adjacent to the thin dense film.

16. A battery cell as in claim 3 wherein the thin dense film is a sodium-ion conductor.

17. A battery cell as in claim 3 wherein the cell is operated at a temperature from about 110° C. to about 350° C.

18. (canceled)

19. (canceled)

20. (canceled)

21. (canceled)

22. (canceled)

23. (canceled)

24. (canceled)

25. (canceled)
